(19) United States
(12) Patent Application Publication
(10) Pub. No.: US 2017/0156975 A1
(43) Pub. Date: Jun. 8, 2017

(54) MASSAGE APPARATUS WITH INTEGRATED ROTATING AND RECIPROCATING MASSAGE MECHANISMS

(71) Applicant: Brookstone Purchasing, Inc., Merrimack, NH (US)

(72) Inventor: Stephen B. MILLS, Atkinson, NH (US)

(21) Appl. No.: 14/959,992

(22) Filed: Dec. 4, 2015

(51) Int. Cl. A61H 23/02; A61H 39/04

(52) U.S. Cl. CPC A61H 23/0254; A61H 39/04; A61H 2201/0207; A61H 2201/0235; A61H 2203/0431

(57) ABSTRACT

A massage apparatus with integrated rotating and reciprocating massage mechanisms is capable of providing distinct shiatsu and tapping massage effects independently and simultaneously. The massage apparatus includes at least one rotating massage node rotating about an axis to form a circular path and at least one reciprocating massage node reciprocating inside the circular path. The rotating massage node(s) may rotate on a rotating base driven by a rotating drive mechanism (e.g., a motor), and the reciprocating massage node(s) may be driven by a reciprocating drive mechanism (e.g., a solenoid) through an aperture in the rotating base. The massage apparatus may include one or more sets of integrated rotating and reciprocating massage mechanisms. The massage apparatus may be enclosed in different types of enclosures (e.g., massage chair, cushion, chair topper, drapable enclosure) configured to engage various parts of the body (e.g., neck, back, shoulders) to impart the massage effects.

### TECHNICAL FIELD

The present invention relates to a massage apparatus and more particularly, to a massage apparatus with integrated rotating and reciprocating massage mechanisms.

### BACKGROUND INFORMATION

Body massagers are known and have been used to impart various different massage effects, such as a shiatsu style kneading effect and an impact tapping or percussion effect. A shiatsu effect may be imparted by a rotary type motion and a tapping effect may be imparted by a generally linear reciprocating type motion. Using one massage apparatus to impart both effects, particularly simultaneously, presents a unique challenge because of the different movements (e.g., rotary and linear) required for each of these effects. Previous attempts at combining shiatsu and tapping effects in a single massage apparatus have used complex mechanisms that are not capable of effectively providing both effects simultaneously. Previous attempts at combining shiatsu and tapping effects in a single massage apparatus have also used a single massage node for both effects and thus do not provide the tapping effect distinct from the shiatsu effect.

### BRIEF DESCRIPTION OF THE DRAWINGS

These and other features and advantages will be better understood by reading the following detailed description, taken together with the drawings wherein:

FIG. 1 is a schematic diagram of a massage apparatus with integrated rotating and reciprocating massage mechanisms, consistent with embodiments of the present disclosure.

FIG. 1A is a schematic diagram of a massage apparatus with multiple sets of integrated rotating and reciprocating massage mechanisms, consistent with embodiments of the present disclosure.

FIG. 2 is a perspective view of an embodiment of a massage apparatus with two sets of integrated rotating and reciprocating massage mechanisms.

FIG. 3 is an exploded view of the massage apparatus shown in FIG. 2 with a top housing.

FIG. 4 is a cross-sectional view of the massage apparatus shown in FIG. 2 taken along line 3-3 and with a pliable cover over the massage nodes.

FIG. 5 is a perspective view of the massage apparatus shown in FIG. 2 without the housing and showing the rotating and reciprocating motions of the massage nodes.

FIG. 6A is a perspective view of a drapable enclosure for the massage apparatus with integrated rotating and reciprocating massage mechanisms, consistent with an embodiment of the present disclosure.

FIG. 6B is a perspective view of a pillow or cushion enclosure for the massage apparatus with integrated rotating and reciprocating massage mechanisms, consistent with an embodiment of the present disclosure.

FIG. 6C is a perspective view of a pillow or cushion enclosure for the massage apparatus with integrated rotating and reciprocating massage mechanisms, consistent with an embodiment of the present disclosure.

FIG. 6D is a perspective view of a massage chair enclosure for the massage apparatus with integrated rotating and reciprocating massage mechanisms, consistent with an embodiment of the present disclosure.

FIG. 6E is a perspective view of a chair topper enclosure for the massage apparatus with integrated rotating and reciprocating massage mechanisms, consistent with an embodiment of the present disclosure.

FIG. 6F is a perspective view of a handheld massage enclosure for the massage apparatus with integrated rotating and reciprocating massage mechanisms, consistent with an embodiment of the present disclosure.

### DETAILED DESCRIPTION

A massage apparatus with integrated rotating and reciprocating massage mechanisms, consistent with embodiments of the present disclosure, is capable of providing distinct shiatsu and tapping massage effects independently and simultaneously. The massage apparatus includes at least one rotating massage node rotating about an axis to form a circular path and at least one reciprocating massage node reciprocating inside the circular path (e.g., along the axis). The rotating massage node(s) may rotate on a rotating base driven by a rotating drive mechanism (e.g., a motor), and the reciprocating massage node(s) may be driven by a reciprocating drive mechanism (e.g., a solenoid) through an aperture in the rotating base, thereby forming integrated rotating and reciprocating massage mechanisms. The massage apparatus may include one or more sets of the integrated rotating and reciprocating massage mechanisms. The massage apparatus may be enclosed in different types of enclosures (e.g., massage chair, cushion, chair topper, drapable enclosure) configured to engage various parts of the body (e.g., neck, back, shoulders) to impart the massage effects.

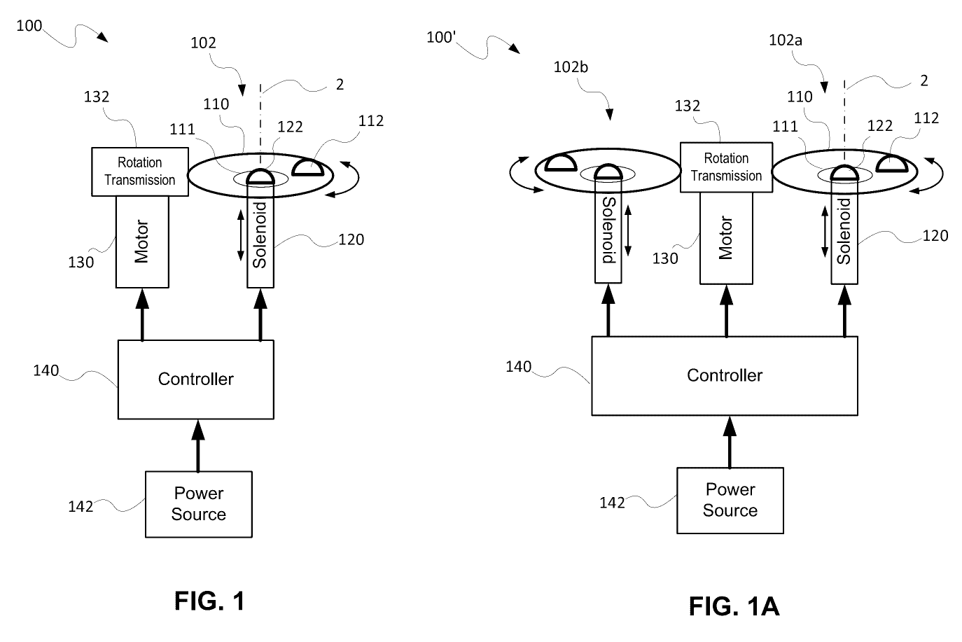

Referring to FIG. 1, a massage apparatus 100, consistent with embodiments of the present disclosure, includes integrated rotating and reciprocating massage mechanisms 102. The integrated rotating and reciprocating massage mechanisms 102 include at least one rotating massage node 112 that revolves around an axis 2 forming a circular path and a reciprocating massage node 122 that reciprocates inside the circular path (e.g., along the same axis 2). A heater, such as a positive temperature coefficient (PTC) heater, may be located in one or more of the massage nodes 112, 122. As used herein, “massage node” refers to a nodule or arrangement of nodules configured to provide at least one point of contact for applying a force to a user to impart a massage effect without limitation of hardness, shape, layout, size or other physical characteristic.

The at least one rotating massage node 112 is coupled to a rotating base 110 that rotates about the axis 2 and is driven by a rotating drive mechanism including, for example, a drive motor 130 and a rotation transmission mechanism 132. The rotation transmission mechanism 132 may include at least a drive gear coupled to the motor 130 and a driven gear coupled to the rotating base 110. Other gears or mechanisms capable of transmitting rotary motion from the motor 130 to the rotating base 120 may also be used. Although a single rotating massage node 112 is shown, multiple rotating massage nodes 112 may be located around the rotating base 110. The multiple rotating massage nodes may have various sizes and/or characteristics (e.g., soft or hard).

The at least one reciprocating massage node 122 is reciprocated along the axis 2 by a reciprocating drive mechanism including, for example, a solenoid mechanism 120 that drives the reciprocating massage node 122 through an aperture 111 in the rotating base 110, thereby integrating the rotating and reciprocating massage mechanisms. In at least one embodiment, the rotation axis and the reciprocation axis may be the same axis 2 (i.e., coincident) in the integrated rotating and reciprocating massage mechanisms 102. In other embodiments, the reciprocation axis may be offset from and/or angled relative to the rotation axis 2 as long as the reciprocation axis is inside the circular path formed by the rotating massage node(s) 112. Thus, the integrated rotating and reciprocating massage mechanisms 102 provides integrated shiatsu and tapping massage effects but separate mechanisms independently drive the rotating massage node(s) 112 and the reciprocating massage node(s) 122. Other types of reciprocating mechanisms may also be used.

The massage apparatus may also include a controller 140 coupled to a power source 142 for controlling power supply to and operation of the motor 130 and the solenoid 120. The power source 142 may include an AC power source (e.g., a household main power source) providing an AC power supply and/or a DC power source (e.g. a battery) providing a DC power supply. The massage apparatus 100 may be configured to be connected to the power source (e.g., via a power cord) or may include the power source 142 (e.g., replaceable or rechargeable batteries) or both. In one embodiment, for example, the massage apparatus 100 may include a rechargeable Li-Ion battery without any power cords.

In one embodiment, the solenoid mechanism 120 includes an AC solenoid that is driven by alternating current and the motor 130 is a DC motor driven by direct current. In this embodiment, the massage apparatus 100 may use an AC power source and the controller 140 may convert AC to DC for the motor 130 or the massage apparatus 100 may use a DC power source and the controller 140 may convert DC to AC (e.g., using an inverter) for the solenoid 120.

In response to user input, the controller 140 may control actuation of the motor 130 and solenoid 120 independently to provide different massage effects or modes, intensities, and/or speeds. Different modes may include one or more of the massage effects such as a shiatsu mode, a tapping mode, and a combined shiatsu/tapping mode. In a shiatsu mode, the controller 140 actuates only the motor 130 to provide only a shiatsu massage effect. In a tapping mode, the controller 140 actuates only the solenoid 120 to provide only a tapping massage effect. In a combined shiatsu/tapping mode, the controller 140 actuates both the motor 130 and the solenoid 120 to provide both the shiatsu and tapping massage effects.

The controller 140 may also control massage intensities or speed for the massage effects. For a shiatsu massage effect, for example, the controller 140 may control the rotation direction and/or speed (e.g., RPM) of the motor 130. For a tapping massage effect, for example, the controller 140 may control the amplitude (i.e., force) and frequency of the solenoid 120 by controlling the amplitude and frequency of the AC current driving the solenoid 120. The controller 140 may also control heaters (not shown) located in one or more massage nodes including turning heaters on or off and adjusting the heat.

The controller 140 may also be capable of providing different massage programs including combinations of massage effects, intensities, speeds and/or heat. The massage programs may be predefined or programmed by a user and may be stored in memory within the controller 140. The program may include any series of massage effects or modes (with or without heat) for predetermined times and with predetermined intensities and/or speeds. One example of a predefined massage program is a pulse program that provides a series of pulsed solenoid activations using a preset time interval and using different power levels applied to the electromagnet. Another example of a predefined massage program is a soothe program that provides a series of pulsed solenoid activations using a ramp up and ramp down time interval and using different power levels applied to the electromagnet during the ramp up and ramp down period. A further example of a predefined massage program is an energize program that provides a series of pulsed solenoid activations using slow ramp up time intervals and using increasing power levels to the electromagnet as the time intervals change.

The controller 140 may be configured using any combination of hardware and/or software known to those skilled in the art and may include at least a processor and memory. The controller 140 may also include a user interface for allowing a user to access and initiate the programs or to create new programs. The controller 140 may also be configured for wireless connection to a separate remote control providing a user interface or to any other electronic device including, without limitation, a PC, a tablet device, a smart phone device or any other computing device.

As shown in FIG. 1A, another embodiment of a massage apparatus 100′ may also include multiple sets of integrated rotating and reciprocating massage mechanisms 102a, 102b. In the illustrated embodiment, the same motor 130 drives both sets of the integrated rotating and reciprocating massage mechanisms 102a, 102b. In other embodiments, separate motors may be used to separately drive the rotation of each of the sets integrated rotating and reciprocating massage mechanisms 102a, 102b and the controller 140 may control the rotation separately. Although two sets of integrated rotating and reciprocating massage mechanisms 102a, 102b are shown, other numbers are within the scope of the present disclosure.

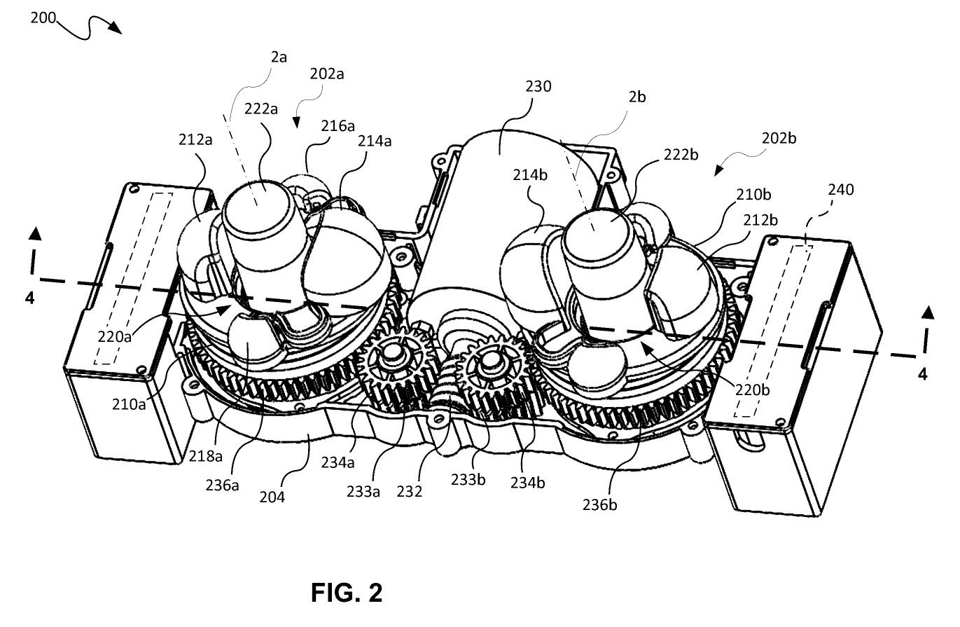

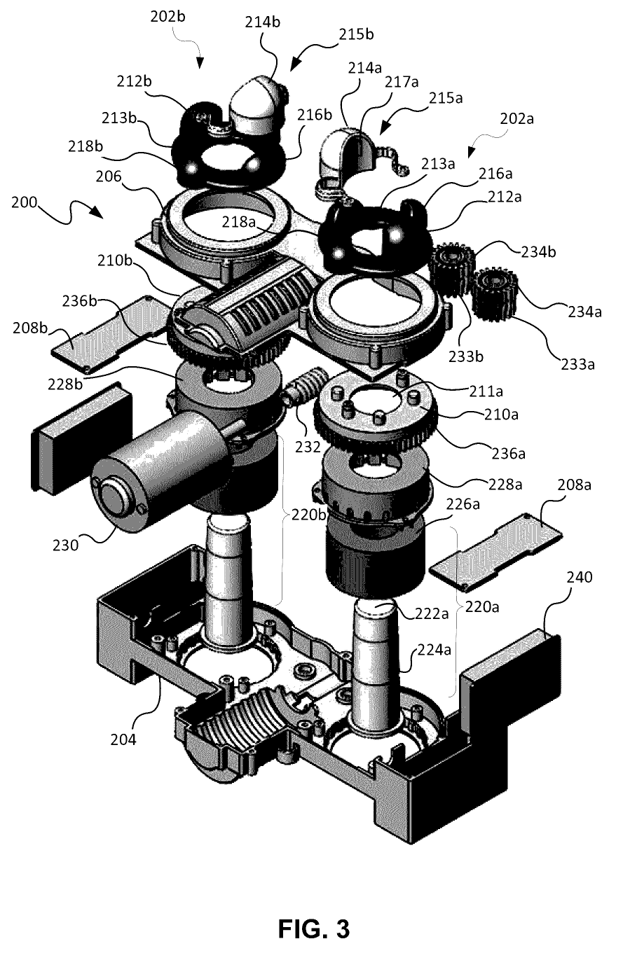

Referring to FIGS. 2-5, an embodiment of a massage apparatus 200 with integrated rotating and reciprocating massage mechanisms is described in greater detail. This embodiment of the massage apparatus 200 includes two sets of integrated rotating and reciprocating massage mechanisms 202a, 202b on respective sides of the massage apparatus 200. Each of the sets of integrated rotating and reciprocating massage mechanisms 202a, 202b include massage nodes, a rotating drive mechanism and a reciprocating drive mechanism, as will be described in greater detail below. The rotating drive mechanisms and reciprocating drive mechanisms may be contained by one or more housings such as a lower housing 204 and upper housing 206, as shown in FIG. 3.

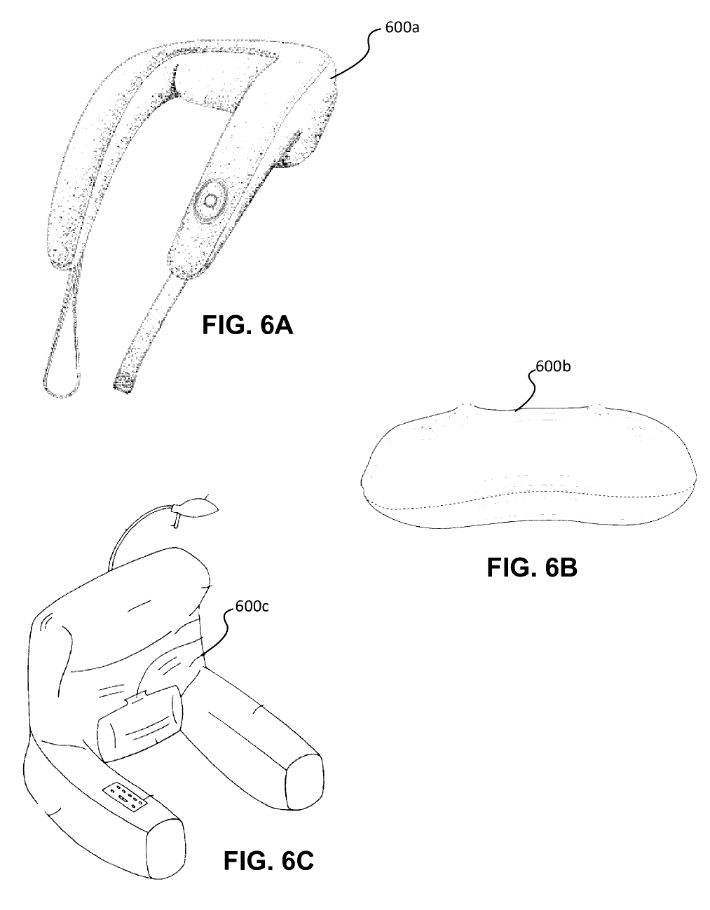

The first set of integrated rotary and reciprocating mechanisms 202a includes rotating massage nodes 212a, 214a, 216a, 218a mounted on a rotating base 210a and a reciprocating massage node 222a mounted on a solenoid mechanism 220a. The rotating base 210a rotates about a first axis 2a and causes the rotating massage nodes 212a, 214a, 216a, 218a to revolve around the first axis 2a (see FIG. 5). The solenoid mechanism 220a reciprocates and causes the reciprocating massage node 222a to reciprocate along the first axis 2a (see FIG. 5).

The rotating massage nodes 212a, 214a, 216a, 218a may have different sizes (e.g., height and/or width) as well as other physical characteristics (e.g., shape or hardness). In the illustrated embodiment, for example, the node 214a is larger than the node 212a, which is larger than the nodes 216a, 218a. One or more of the rotating massage nodes 212a, 214a, 216a, 218a, for example, may be made of a harder plastic material or a softer elastomeric material. As shown in greater detail in FIG. 3, fixed massage nodes 212a, 216a, 218a may be formed as a molded piece with a base 213a and at least one massage node 214a may be formed by a separate node member 215a of a softer elastomeric material attached to the base 213a (e.g., positioned over one of the fixed nodes). The separate node member 215a may include one or more PTC heaters 217a (see FIG. 3) and may include one or more electrical connections to the PTC heater 217a. The reciprocating massage node 222a may be made from a rigid plastic material or an elastomeric material.

The rotating base 210a is operably coupled to a motor 230 via a series of gears 232, 233a, 234a, 236a such that the motor 230 drives and rotates the rotating base 210a. In particular, a driving gear 232 (e.g., a worm gear) is coupled to the motor 230, a driven gear 236a is coupled to the rotating base 210a, and reduction gears 233a, 234a transfer rotary motion from the drive gear 232 to the driven gear 236a to rotate the rotating base 210a.

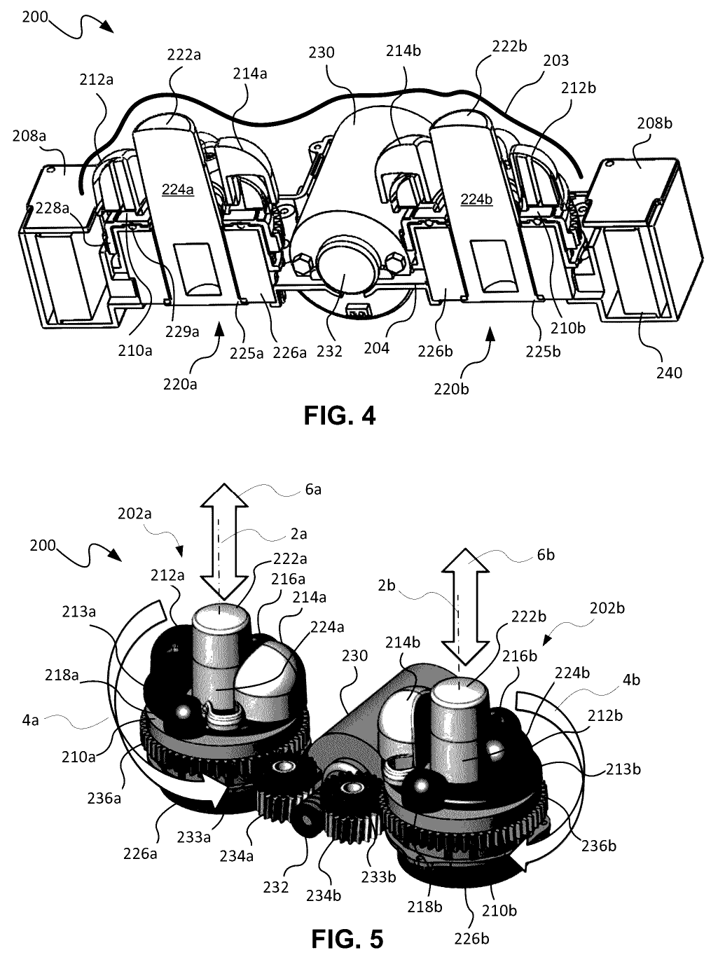

As shown in greater detail in FIGS. 3 and 4, the solenoid mechanism 220a includes a solenoid plunger 224a slidably positioned within an electromagnet 226a and extending through an aperture 211a in the rotating base 210a. The electromagnet 226a may include a coil that produces a magnetic field when a current passes through. The solenoid plunger 224a may include a ferrous material capable of interacting with the magnetic field such as, for example, 10-18 cold-rolled steel. An AC current applied to the electromagnet 226a generates a magnetic field that causes the solenoid plunger 224a to move linearly and to reciprocate within the electromagnet 226a as the polarity changes, as is generally known to those skilled in the art. The solenoid mechanism 220a may also include a spring (not shown) that retracts the solenoid plunger 224a instead of or in addition to a powered retract. If a DC solenoid mechanism is used, for example, the DC solenoid mechanism may use a spring to provide a spring return for the solenoid plunger.

The solenoid plunder 224a includes the reciprocating massage node 222a at one end, which may include a tip made of a soft material such as plastic and/or an elastomer. The solenoid plunger 224a includes a stop 225a at the other end, which limits movement of the solenoid plunger 224a within the electromagnet 226a.

An electromagnet housing 228a may be located around at least a top portion of the electro magnet 226a, and the rotating base 210a and driven gear 236a may be rotatably mounted on the electromagnet housing 228a. The apertures in the electromagnet 226a and the electromagnet housing 228a are aligned with the aperture 211a in the rotating base 210a. A bearing 229a (see FIG. 4) may be located between the rotating base 210a and the electromagnet housing 228a to facilitate rotation.

The second set of integrated rotating and reciprocating massage mechanisms 202b similarly includes rotating massage nodes 212b, 214b, 216b, 218b mounted on a rotating base 210b and a reciprocating massage node 222b mounted on a solenoid mechanism 220b. The rotating base 210b is operably coupled to the motor 320 via gears 232, 233b, 234b, 236b for rotating the rotating base 210b. Thus, the motor 230 and the drive gear 232 drive the rotating bases 210a, 210b for both sets of integrated rotating and reciprocating massage mechanisms 202a, 202b. The second solenoid mechanism 210b similarly includes a solenoid plunger 224b received within an electromagnet 226b with an electromagnet housing 228b over the electromagnet 226b and a stop 225b limiting travel of the solenoid plunger 224b.

As shown in FIG. 4, one or more pliable covers 203 may be located over at least the rotating massage nodes 212a, 214a, 216a, 218a, 212b, 214b, 216b, 218b and the reciprocating massage nodes 222a, 222b. The pliable cover 203 includes a pliable material, such as fabric, which is capable of covering the massage nodes while also allowing a user to feel the movement of the massage nodes and the massage effects. Electronics for operating and controlling the motor 230 and solenoid mechanisms 220a, 220b, such as one or more controller circuit boards 240, may be located in compartments at ends of the massage apparatus 200. Covers 208a, 208b may cover the compartments including the electronics.

As shown in FIG. 5, rotation of the motor 230 causes the first set of rotating massage nodes 212a, 214a, 216a, 218a to rotate about the first axis 2a in the direction of arrow 4a and causes the second set of rotating massage nodes 212b, 214b, 216b, 218b to rotate about the second axis 2b in the direction of arrow 4b. Thus, the motor 230 rotates the first and second sets of rotating massage nodes in opposite directions. The motor 230 may be reversed to rotate in the opposite directions of the arrows 4a, 4b. Applying an alternating current to the electromagnets 226a, 226b causes the reciprocating massage nodes 222a, 222b reciprocate along the axes 2a, 2b in the direction of arrows 6a, 6b.

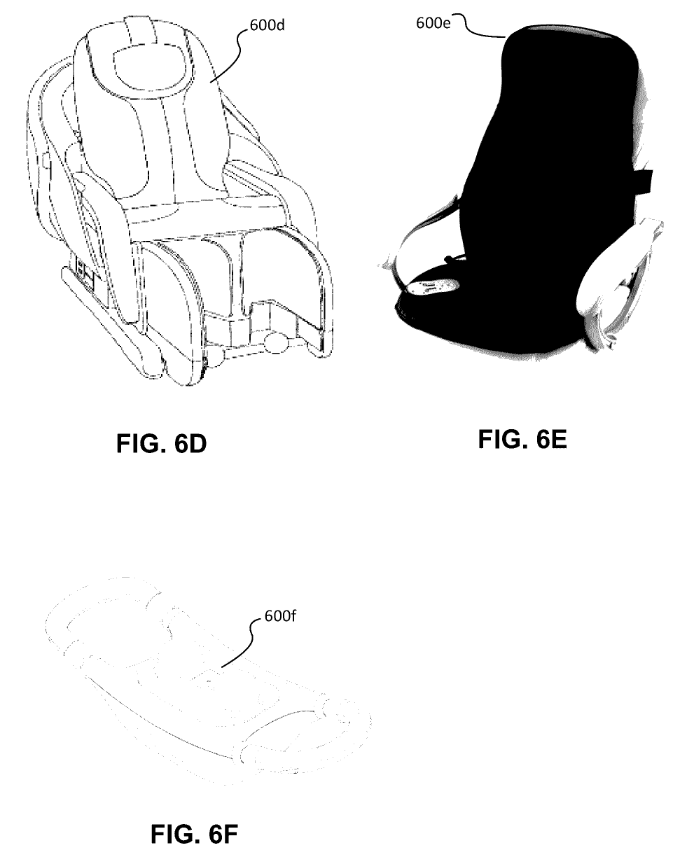

Embodiments of the massage apparatus described herein may be applied to any part of the body and may be placed in any type of enclosure that permits the massage apparatus to be placed against the body of the user to impart the massage effects described herein. FIGS. 6A-6E show various enclosures that may include a massage apparatus with integrated rotating and reciprocating massage mechanisms as described herein. As shown in FIG. 6A, the massage apparatus may be used in a drapable enclosure 600a configured to be draped across shoulders of a user. As shown in FIGS. 6B and 6C, the massage apparatus may be used in a pillow or cushion enclosure 600b, 600c for contacting the neck, back or shoulders of the user. As shown in FIG. 6D, the massage apparatus may be used in a massage chair enclosure 600d for contacting the neck, back and/or shoulders of the user while sitting in the chair. As shown in FIG. 6E, the massage apparatus may be used in a chair topper enclosure 600e for contacting the neck, back and/or shoulders of the user while sitting in the chair. As shown in FIG. 6F, the massage apparatus may be used in a handheld massage enclosure 600f. In some embodiments, such as the massage chair, more than one massage apparatus may be used.

Accordingly, a massage apparatus with integrated rotating and reciprocating massage mechanisms, consistent with embodiments described herein, allows the rotating massage mechanism to be operated separately from the reciprocating massage mechanism, and vice versa, to provide independent shiatsu and tapping massage effects either separately or simultaneously.

Consistent with an embodiment, massage apparatus includes at least one motor, at least a first rotation transmission mechanism operably coupled to the motor, and at least a first rotating base operably coupled to the first rotation transmission mechanism. The first rotating base includes an aperture aligned with a first axis and is configured to rotate about the first axis when driven by the motor. At least a first rotating massage node extends from the first rotating base and moves with the first rotating base to revolve around the first axis forming a circular path. The massage apparatus further includes at least a first reciprocating mechanism aligned with the aperture of the first rotating base. The first reciprocating mechanism is configured to reciprocate inside the circular path. At least a first reciprocating massage node is coupled to the first reciprocating mechanism and moves with the first reciprocating mechanism inside the circular path.

Consistent with another embodiment, a method provides a rotating massage effect and a reciprocating massage effect distinctly and simultaneously. The method includes: rotating at least one rotating base about an axis, the rotating base including at least one rotating massage node that revolves about the first axis forming a circular path and including a central aperture; and reciprocating at least one reciprocating mechanism inside the circular path and through the aperture, the reciprocating mechanism including at least one reciprocating massage node that reciprocates inside the circular path with the reciprocating mechanism.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A massage apparatus comprising:
at least one motor;
at least a first rotation transmission mechanism operably coupled to the motor;
at least a first rotating base operably coupled to the first rotation transmission mechanism, wherein the first rotating base includes an aperture aligned with a first axis and is configured to rotate about the first axis when driven by the motor;
at least a first rotating massage node extending from the first rotating base and moving with the first rotating base to revolve around the first axis forming a circular path;
at least a first reciprocating mechanism aligned with the aperture of the first rotating base, wherein the first reciprocating mechanism is configured to reciprocate inside the circular path; and
at least a first reciprocating massage node coupled to the first reciprocating mechanism and moving with the first reciprocating mechanism inside the circular path.

2. The massage apparatus of claim 1 wherein the first reciprocating mechanism reciprocates along a reciprocation axis that is coincident with the first axis.

3. The massage apparatus of claim 1 further comprising a controller coupled to the motor and the first reciprocating mechanism and configured to control actuation of the motor and the reciprocating mechanism.

4. The massage apparatus of claim 3 wherein the controller is configured to provide at least three modes including a shiatsu mode wherein the controller actuates only the motor, a tapping mode wherein the controller actuates only the reciprocating mechanism, and a combined shiatsu/tapping mode wherein the controller actuates both the motor and the reciprocating mechanism simultaneously.

5. The massage apparatus of claim 3 wherein the controller is configured to actuate the motor and the reciprocating mechanism independently.

6. The massage apparatus of claim 3 wherein the controller is configured to actuate the motor and the reciprocating mechanism simultaneously.

7. The massage apparatus of claim 3 wherein the reciprocating mechanism includes a solenoid mechanism.

8. The massage apparatus of claim 7 wherein the controller is configured to control an alternating current supplied to the solenoid mechanism.

9. The massage apparatus of claim 3 wherein the controller is configured to control at least a rotation direction of the motor and a force and frequency of the reciprocating mechanism.

10. The massage apparatus of claim 1 further comprising a PTC heater located in at least one of the rotating massage node and the reciprocating massage node.

11. The massage apparatus of claim 1 further comprising:
at least a second rotating base operably coupled to the motor, wherein the second rotating base includes an aperture aligned with a second axis and is configured to rotate about the second axis when driven by the motor;
at least a second rotating massage node extending from the second rotating base and moving with the second rotating base to revolve around the second axis;
at least a second reciprocating mechanism aligned with the aperture of the second rotating base, wherein the second reciprocating mechanism is configured to reciprocate inside of the circular path; and
at least a second reciprocating massage node coupled to the second reciprocating mechanism and moving with the second reciprocating mechanism inside the circular path.

12. The massage apparatus of claim 1 wherein the rotation transmission mechanism includes at least one drive gear coupled to the motor and at least one driven gear coupled to the rotating base.

13. The massage apparatus of claim 1 wherein the at least a first rotating massage node includes a plurality of rotating massage nodes extending from the first rotating base.

14. The massage apparatus of claim 13 wherein the plurality of rotating massage nodes have different sizes.

15. The massage apparatus of claim 1 wherein the first rotating massage node includes an elastomeric material.

16. The massage apparatus of claim 1 further comprising an enclosure for enclosing the motor, the rotating base, the rotating massage node, the reciprocating mechanism and the reciprocating massage node, wherein the enclosure includes at least a pliable cover covering the rotating massage node and the reciprocating massage node.

17. The massage apparatus of claim 16 wherein the enclosure is selected from the group consisting of a massage chair enclosure, a chair topper enclosure, a cushion enclosure, and a drapable enclosure configured to drape across shoulders of a user.

18. A method of providing a rotating massage effect and a reciprocating massage effect distinctly and simultaneously, the method comprising:
rotating at least one rotating base about an axis, the rotating base including at least one rotating massage node that revolves about the first axis to form a circular path, the rotating base including a central aperture; and
reciprocating at least one reciprocating mechanism inside the circular path and through the central aperture, the reciprocating mechanism including at least one reciprocating massage node that reciprocates inside the circular path with the reciprocating mechanism.

19. The method of claim 18 further comprising controlling rotation of the rotating base and reciprocation of the reciprocating mechanism such that rotating base is rotating and the reciprocating mechanism is reciprocating simultaneously.

20. The method of claim 18 further comprising controlling rotation of the rotating base and reciprocation of the reciprocating mechanism such that rotating base is rotating without reciprocating the reciprocating mechanism or the reciprocating mechanism is reciprocating without rotating the rotating base.
